(19) United States
(12) Patent Application Publication
(10) Pub. No.: US 2020/0265348 A1
(43) Pub. Date: Aug. 20, 2020

(54) Resource Allocation Using Weighted Metrics

(71) Applicant: ANI TECHNOLOGIES PRIVATE LIMITED, Bengaluru (IN)

(72) Inventors: Abhishek Nimesh, Allahabad (IN); Nilesh Hiray, Bangalore (IN); Tanuj Rajvanshi, New Delhi (IN); Harsh Vardhan, Ara (IN)

(73) Assignee: ANI TECHNOLOGIES PRIVATE LIMITED, Bengaluru (IN)

(21) Appl. No.: 16/793,467

(22) Filed: Feb. 18, 2020

(30) Foreign Application Priority Data
Feb. 18, 2019 (IN) 201941006384

(51) Int. Cl. G06Q 10/02; G06Q 10/06; G01C 21/34; G08G 1/00; G06Q 50/30

(52) U.S. Cl. CPC G06Q 10/02; G06Q 10/06314; G06Q 50/30; G01C 21/3492; G08G 1/202; G06Q 10/06315

(57) ABSTRACT

A method and a system for allocating vehicles to passengers are provided. Booking requests for rides are received from passenger devices of passengers. Available vehicles are identified for allocation corresponding to the booking requests. A matrix is generated in which each element corresponds to each booking request-vehicle pair. Each element is determined based on one or more parameter values corresponding to one or more parameters associated with each booking request-vehicle pair and a weight associated with each parameter. The matrix is further processed by means of a Hungarian algorithm to generate another matrix. A vehicle from the available vehicles is allocated to a passenger from the passengers based on the another matrix.

### CROSS-RELATED APPLICATIONS

This application claims priority of Indian Application Serial No. 201941006384, filed Feb. 18, 2019, the contents of which are incorporated herein by reference.

### FIELD

Various embodiments of the disclosure relate generally to allocation systems. More specifically, various embodiments of the disclosure relate to resource allocation using weighted metrics.

### BACKGROUND

With the advent of the Internet, online booking for various on-demand products or services has increased enormously. For example, when a booking request is initiated by a customer for a vehicle service, a processing server allocates an available vehicle to the customer for offering the vehicle service. In another example, when a purchase request is initiated by a customer for a product, a processing server generates a task corresponding to the purchase request and allocates the task to a worker for handling the purchase request.

With continuous increase in the popularity of online bookings, the number of requests generated for availing the various on-demand products or services are enormously increasing on a daily basis. As a result, the current processing server is taking more time to process the humongous number of booking requests, and thus delaying supply of the various on-demand products or services, which is not desirable to various customers. In addition, the current processing server performs allocation of various resources based on a single parameter that is relevant to the specific allocation ecosystem. Since a group of different parameters drives any business, use of the single parameter does not provide an optimal solution. In fact, such allocation degrades the overall customer's experience as well as the overall revenue collection of various product or service providers. In order to overcome the shortcomings of using the single parameter, in few scenarios, the current processing sever performs sequential ranking based on the multiple parameters. However, in such scenarios, the ranking strategy applied at the end is the most dominant one and easily supersedes the results of any previously run ranking strategy, which may not provide the optimal solution.

In light of the foregoing, there exists a need for a technical and reliable solution that overcomes the above-mentioned problems, challenges, and short-comings, and performs optimal allocation of resources to various entities that offers best experiences to product or service providers (such as cab service providers) or end users such as customers who are willing to avail various products or services from the product or service providers in an online manner, which in turn may maximize inflow of online requests for various on-demand services. Also, such optimal allocation of the resources saves time and enables the server to handle a large number of requests in an effective and efficient manner on daily basis.

### SUMMARY

Resource allocation using weighted metrics is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an environment for vehicle allocation, in accordance with an exemplary embodiment of the disclosure;

FIG. 2 is a block diagram that illustrates a transportation server of the environment of FIG. 1, in accordance with an exemplary embodiment of the disclosure;

FIGS. 3A-3C, collectively, illustrate an exemplary scenario for optimizing vehicle allocation, in accordance with an exemplary embodiment of the disclosure;

FIG. 4 is a flow chart that illustrates a method for allocating vehicles to passengers, in accordance with an exemplary embodiment of the disclosure;

FIG. 5 is a flow chart that illustrates a method for optimizing resource allocation, in accordance with an exemplary embodiment of the disclosure; and

FIG. 6 is a block diagram that illustrates a computer system for optimizing resource allocation, in accordance with an exemplary embodiment of the disclosure.

### DETAILED DESCRIPTION

An embodiment of the present disclosure provides a resource allocation method. The resource allocation method includes one or more operations that are executed by circuitry of a server to receive one or more requests for performing one or more tasks. In an embodiment, the one or more requests may be initiated by one or more individuals, respectively. The circuitry identifies one or more resources that are available for allocation corresponding to the one or more requests. Further, a first matrix including a plurality of elements is generated. Each element in the matrix corresponds to a distinct request-resource pair and is determined based on a plurality of parameter values corresponding to a plurality of parameters that are associated with the request-resource pair and a weight associated with each parameter. The circuitry further processes the first matrix by means of one or more algorithms, such as Hungarian algorithm, to generate a second matrix. Thereafter, the circuitry allocates a resource to a request for performing the one or more tasks based on the second matrix.

Another embodiment of the present disclosure provides vehicle allocation methods and systems for optimizing allocation of vehicles to passengers in a transportation system. The method includes one or more operations that are executed by circuitry of the system to receive one or more booking requests from one or more passenger devices of one or more passengers, respectively. A booking request is a request for booking a vehicle for a ride between a pick-up location and a drop-off location. The circuitry identifies one or more vehicles that are available for allocation corresponding to the one or more booking requests. The circuitry further determines one or more booking request-vehicle pairs based on the one or more booking requests and the one or more available vehicles. Each booking request-vehicle pair is a distinct pair that associates a booking request from the one or more booking requests with an available vehicle from the one or more available vehicles.

The circuitry further generates a first matrix including a plurality of elements. Each element in the first matrix corresponds to a booking request-vehicle pair. Further, each element is determined based on a plurality of parameter values corresponding to a plurality of parameters associated with each booking request-vehicle pair and a weight associated with each parameter. The plurality of parameters includes at least two parameters from a pick-up distance, a pick-up time, a ride cost, a dry run, an idle time, a driver rating, a passenger rating, a gross merchandise value (GMV), an earning normalizing value (ENV), or a vehicle type associated with each booking request-vehicle pair. The circuitry further processes the first matrix by means of one or more algorithms, such as the Hungarian algorithm, to generate a second matrix. Thereafter, the circuitry allocates an available vehicle to a passenger for the ride based on the second matrix.

Thus, the present disclosure provides an optimal allocation of vehicles to passengers. The present disclosure takes into consideration multiple parameters for allocation of the vehicles. The weights associated with the parameters can be adjusted based on business requirements of the transportation service provider. Thus, the vehicles are allocated to the passengers, wherein the cost may be minimized and the profits may be maximized for the transportation service provider.

### Terms Description (in Addition to Plain and Dictionary Meaning)

Vehicle is a means of transport that is deployed by a transport service provider, such as a cab service provider (e.g., OLA), to provide on-demand vehicle services to one or more passengers. For example, the vehicle is an automobile, a bus, a car, a bike, or the like. The one or more passengers may travel in the vehicle to commute between pick-up and drop-off locations.

Passenger is an individual who wants to travel from one location to one or more other locations using a vehicle service facilitated by a transport service provider. For using the vehicle service, the passenger initiates a booking request for a ride with the transport service provider in an online manner and provides ride details, such as a pick-up location, a drop-off location, a vehicle type, a pick-up time, or a combination thereof.

Driver is an individual who drives a vehicle for providing on-demand vehicle services to one or more passengers. The driver may register with a transport service provider (e.g., a cab service provider such as OLA) for providing the on-demand vehicle services to the one or more passengers. The driver drives the vehicle to pick the one or more passengers from their pick-up locations and then transports the one or more passengers to their drop-off locations based on allocation of the vehicle to the one or more passengers by the transport service provider.

Booking request is a request for a ride, for example, a share-ride, a non-share ride, a rental ride, or the like, that is initiated by a passenger to travel from one location to one or more other locations. The booking request includes a pick-up location, a drop-off location, a vehicle type, a pick-up time, or a combination thereof. The passenger may initiate the booking request for the ride from the same pick-up location or a different location. In case of the different location, the passenger provides the pick-up location for the ride.

Pick-up location is a point of location in a geographical area from where a passenger is picked-up by a driver of a vehicle for a ride in the vehicle. The term pick-up location may be interchangeably used as a source location.

Drop-off location is a point of location in a geographical area where a passenger wants to travel from a pick-up location. The term drop-off location may be interchangeably used as a destination location.

Booking request-vehicle pair represents pairing of a booking request with a vehicle that is available for allocation.

Parameter is a variable that is used for allocating an available vehicle to a passenger. The parameter may correspond to one of a pick-up distance, a pick-up time, a ride cost, a dry run, an idle time, a driver rating, a passenger rating, a gross merchandise value (GMV), an earning normalizing value (ENV), or a vehicle type associated with each booking request-vehicle pair.

Pick-up distance associated with a booking request-vehicle pair is a distance that is determined based on a current location of an available vehicle and a pick-up location of a passenger associated with the booking request-vehicle pair.

Pick-up time associated with a booking request-vehicle pair is a time instance at which (or a minimum time duration around which) a passenger will be picked by a driver of an available vehicle for a ride requested by the passenger. The pick-up time is determined based on at least a pick-up distance and traffic conditions along a route associated with the pick-up distance.

Ride fare is a service fee that is charged by a transport service provider to a passenger for using a vehicle service, for example, a cab that is offered by the transport service provider to the passenger for a ride between two or more locations. The passenger may pay the ride fare for the ride either in cash or using digital money. The term ride fare may be interchangeably used as a ride cost herein. In an embodiment, the ride cost associated with a booking request-vehicle pair is determined based on at least a ride type, a vehicle type, a ride distance between pick-up and drop-off locations, a ride time between the pick-up and drop-off locations, real-time traffic conditions between pick-up and drop-off locations, real-time supply and demand, or a combination thereof.

Dry run for an available vehicle associated with a booking request-vehicle pair is a time duration that is determined based on a dry run distance for which a driver drives an available vehicle without any passenger to reach a pick-up location of a passenger associated with the booking request-vehicle pair.

Idle time for an available vehicle is a time interval during which the available vehicle has not been allocated to any passenger. The idle time may be determined based on previous allocation information associated with the available vehicle.

Gross merchandise value (GMV) indicates a total value (in terms of revenue or earnings) per unit of distance or time, or over a defined distance or a time duration. The GMV for a booking request-vehicle pair is determined based on a ride cost and a ride distance between pick-up and drop-off locations associated with the booking request-vehicle pair.

(Insert) ENV indicates deviation in earnings of a driver with respect to other drivers who are driving their vehicles on the same platform facilitated by a transport service provider. The ENV for a booking request-vehicle pair is determined based on the earnings of one or more drivers associated with one or more vehicles, respectively.

Matrix is an array of elements that is arranged in rows and columns. Each element of the matrix may include a number, a symbol, or an expression. In an embodiment, each element of the matrix corresponds to a request-vehicle pair such that a column of the matrix indicates a vehicle of the request-vehicle pair and a row of the matrix indicates a request of the request-vehicle pair, or vice-versa.

Hungarian algorithm is a combinatorial optimization algorithm that solves assignment problems in a polynomial time. The combinatorial optimization facilitates operations, such as finding of an optimal object from a finite set of objects.

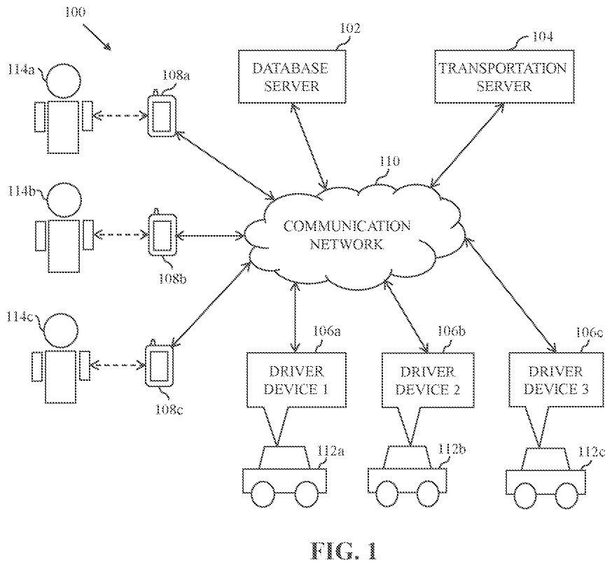

FIG. 1 is a block diagram that illustrates an environment 100 for vehicle allocation, in accordance with an exemplary embodiment of the disclosure. The environment 100 includes a database server 102, a transportation server 104, driver devices 106a-106c, and passenger devices 108a-108c that communicate with each other by way of a communication network 110. The driver devices 106a-106c are associated with vehicles 112a-112c, respectively, and the passenger devices 108a-108c are associated with passengers 114a-114c, respectively.

For simplicity, FIG. 1 shows only three driver devices (such as the driver devices 106a-106c) and three passenger devices (such as the passenger devices 108a-108c). However, it will be apparent to a person having ordinary skill in the art that the disclosed embodiments may be implemented using any number of passenger devices and any number of driver devices, without departing from the scope and spirit of the present disclosure.

The database server 102 may include suitable logic, circuitry, interfaces, and/or code, executable by the circuitry, that may be configured to perform one or more database operations. The database server 102 may be a data management and storage computing device that is communicatively coupled with the communication network 110 and performs the one or more database operations, such as receiving, storing, processing, and transmitting queries, data, content, or the like. The query, data, or content is received/transmitted from/to various components of the environment 100, such as the transportation server 104, the driver devices 106a-106c, or the passenger devices 108a-108c. In an embodiment, the database server 102 includes a processor (not shown) and a memory (not shown) for managing and storing the queries, data, or content. For example, the database server 102 stores historical travel data of various historical rides associated with one or more individuals, such as drivers (not shown) associated with the vehicles 112a-112c and the passengers 114a-114c. The historical travel data includes information corresponding to historical demand and supply associated with one or more geographical areas (hereinafter, “geographical areas”) and historical pick-up and drop-off locations associated with each historical demand and supply. The historical travel data further includes historical feedback and comments for the drivers and the passengers 114a-114c provided by the passengers 114a-114c and the drivers, respectively.

Further, the database server 102 stores driver information of the drivers, vehicle information of the vehicles 112a-112c, passenger information of the passengers 114a-114c, or the like. The driver information of each driver includes at least a driver name, a driver contact number, a driving license identifier (ID), a driver registration ID, a registered vehicle make, a vehicle registration ID, a driver's vehicle type, a driver rating, feedback and comments, a home address, or other driver-related information. The vehicle information of each vehicle includes a vehicle type, a vehicle capacity, a vehicle number, or other vehicle-related information. The passenger information of each passenger includes a passenger name, a passenger contact number, a passenger registration ID, a passenger rating, or other passenger-related information. The database server 102 may further store historical traffic data (of the geographical areas) that has been observed or captured at various time instances or intervals in the past. The historical traffic data may be used to predict traffic conditions in real-time along various routes of the geographical areas.

Further, the database server 102 stores real-time travel data, such as real-time booking status and position information, of a set of vehicles (e.g., the vehicles 112a-112c) that may be operating on a service platform facilitated by a transport service provider (e.g., a cab service provider such as OLA). The real-time booking status information associated with a vehicle, such as the vehicle 112a, indicates the current allocation status (e.g., allocated or unallocated) for the vehicle 112a. The real-time position information of the vehicle 112a indicates the current location of the vehicle 112a in a geographical area by means of latitude information, longitude information, altitude information, or a combination thereof.

In an embodiment, the database server 102 may receive a query from the transportation server 104 to retrieve the historical travel data, the historical traffic data, the driver information, the vehicle information, the passenger information, or the like. The database server 102, in response to the received query, retrieves and transmits the requested information to the transportation server 104 over the communication network 110. Examples of the database server 102 include, but are not limited to, a personal computer, a laptop, or a network of computer systems.

The transportation server 104 may include suitable logic, circuitry, interfaces, and/or code, executable by the circuitry, that may be configured to perform one or more operations for resource allocation such as vehicle allocation. The transportation server 104 may be a computing device, which may include a software framework, that may be configured to create the transportation server implementation and perform the various operations associated with the resource allocation. The transportation server 104 may be realized through various web-based technologies, such as, but not limited to, a Java web-framework, a .NET framework, a PHP framework, a python framework, or any other web-application framework. Examples of the transportation server 104 may include, but are not limited to, a personal computer, a laptop, or a network of computer systems. Also, the transportation server 104 may be associated with the transport service provider (e.g., a cab service provider such as OLA) that facilitates on-demand vehicle services to passengers in the geographical areas.

In an embodiment, the transportation server 104 receives one or more booking requests (hereinafter, “booking requests”) for various types of rides from various passenger devices (such as the passenger devices 108a-108c) of various passengers (such as the passengers 114a-114c) in real-time. Each booking request includes at least a pick-up location, a drop-off location, a pick-up time, a vehicle type, or a combination thereof, along with the passenger information, such as the passenger name, gender, rating, or the like. The various types of rides may be intra-city rides for travelling within a city, inter-city rides for travelling from one city to another city, or a combination thereof. The intra-city rides may be share-rides, no-share rides, fixed rental rides, or the like. Upon receipt of the booking requests, the transportation server 104 retrieves the real-time booking status and position information of the set of vehicles associated with the transport service provider from the database server 102. Thereafter, the transportation server 104 processes the real-time booking status information to identify one or more vehicles, such as the vehicles 112a-112c, that are currently available for new allocation or will be available in near future time (i.e., after a defined time period, for example, “5 minutes”). The vehicles 112a-112c are identified to initiate allocation processes corresponding to the booking requests received from the passenger devices 108a-108c. The transportation server 104 further processes the real-time position information to detect the current location of each vehicle such as the vehicles 112a-112c. The transportation server 104 further retrieves the driver and vehicle information associated with each of the drivers and the vehicles 112a-112c from the database server 102.

Further, the transportation server 104 identifies all possible booking request-vehicle pairs based on the booking requests (received from the passenger devices 108a-108c) and the vehicles 112a-112c that are available for allocation corresponding to the booking requests. The transportation server 104 further selects a plurality of parameters from a set of parameters including at least a pick-up distance, a pick-up time, a ride cost, a dry run, an idle time, a driver rating, a passenger rating, a gross merchandise value (GMV), an earning normalizing value (ENV), and a vehicle type. In one example, the plurality of parameters may be selected from the set of parameters based on predefined settings by an administrator of the transport service provider. In another example, the plurality of parameters may be selected from the set of parameters based on a rating of each parameter. Each parameter may be rated based on driver's preferences, passenger's preferences, administrator's preferences, or a combination thereof. Such preferences may have been defined by the individuals (such as the drivers, the passengers 114a-114b, or the administrator) in the past (i.e., before the receipt of the booking requests) or may be defined in the real-time (i.e., during or after initiation of the booking requests).

The transportation server 104 further generates a plurality of matrices corresponding to the plurality of parameters based on their respective parameter values determined for each booking request-vehicle pair. The parameter values may be determined based on the received booking requests, the historical travel data, the passenger information of the passengers 114a-114c, the driver information of the drivers of the vehicles 112a-112c, the real-time travel data, or a combination thereof.

The transportation server 104 further retrieves a weight corresponding to each parameter from the database server 102. In another example, the weight corresponding to each parameter may be received directly from an administrator computing device (not shown) of the administrator. Thereafter, the transportation server 104 processes the plurality of matrices using their respective weights and generates a unified matrix. The transportation server 104 further processes the unified matrix using one or more algorithms, such as the Hungarian algorithm, to obtain an optimized matrix including a plurality of optimized values. The transportation server 104 allocates the vehicles 112a-112c to the passengers 114a-114c based on the optimized matrix.

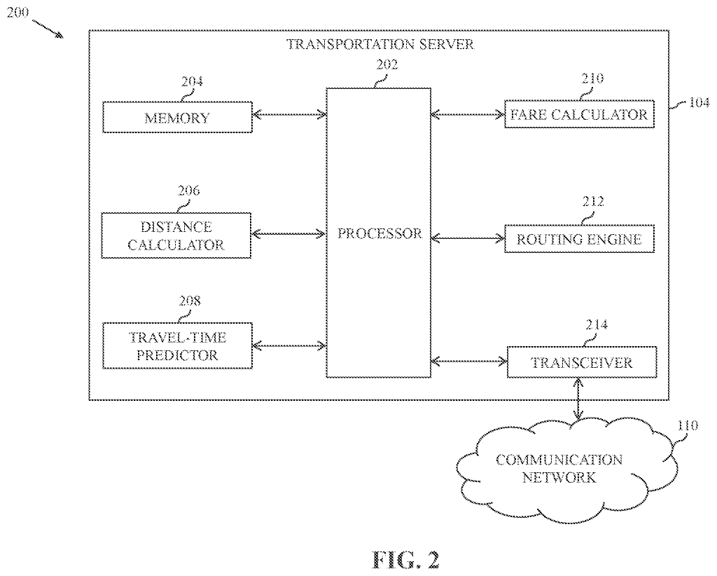

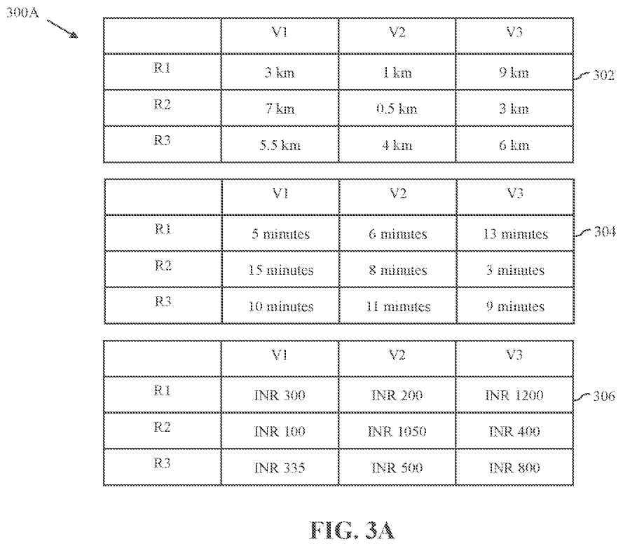

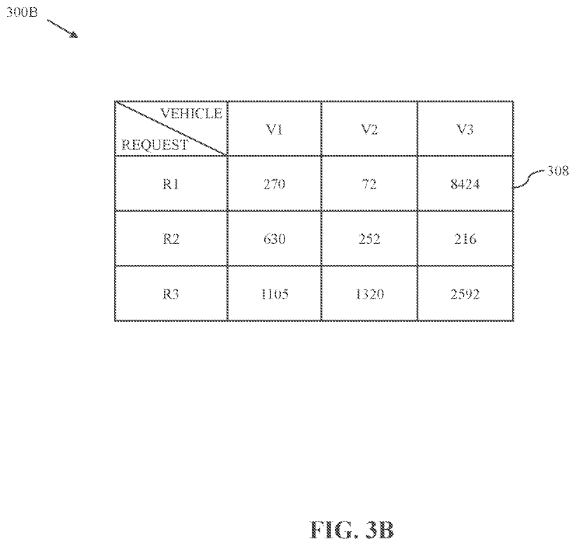

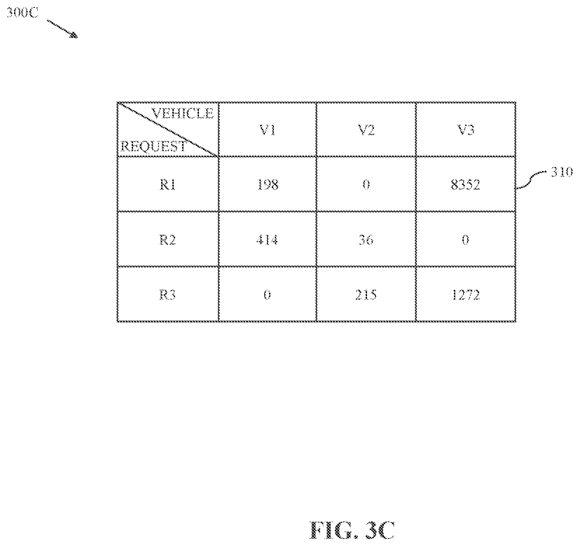

Further, in an embodiment, the transportation server 104 renders a first user interface on each of the passenger devices 108a-108c for presenting the respective allocation information. The allocation information includes at least one of the driver information, the vehicle information, the ride fare information, the estimated pick-up and drop-off time information, or the like. The transportation server 104 further renders a second user interface on each of the driver devices 106a-106c for presenting the respective allocation information. The allocation information includes the passenger information, the vehicle information, the ride fare information, the estimated pick-up and drop-off time information, or the like. The second user interface further includes an electronic map for directing or navigating each driver between two or more locations based on her allocation. Various components of the transportation server 104 along with their operations have been described in detail in conjunction with FIGS. 2 and 3A-3C.

A person having ordinary skill in the art will understand that the scope of the present disclosure is not limited to realization of the database server 102 and the transportation server 104 as separate entities. In an embodiment, the functionalities of the database server 102 may be integrated into the transportation server 104, or vice-versa, without departing from the spirit of the disclosure. Further, in an embodiment, the transportation server 104 may be realized as an application program installed on and/or running on each of the driver devices 106a-106c and/or the passenger devices 108a-108c, without departing from the spirit of the disclosure.

The driver device 106a may include suitable logic, circuitry, interfaces, and/or code, executable by the circuitry, that may be configured to perform one or more operations. In an embodiment, the driver device 106a is a computing device that is used by the driver of the vehicle 112a to perform one or more activities by means of a service application installed on the driver device 106a. For example, the driver of the vehicle 112a uses the driver device 106a to view a new booking request communicated by the transportation server 104. The driver further uses the driver device 106a to accept or reject the new booking request. The driver further uses the driver device 106a to view the passenger information and direction information between two or more locations based on allocation of the vehicle 112a by the transportation server 104. The direction information may be presented in form of the electronic map. The driver further uses the driver device 106a to input her preferences for the various parameters and/or various types of rides, locations, working time durations, or the like.

The driver device 106a also transmits log-in information (such as a log-in time or a log-out time) of the driver of the vehicle 112a to the database server 102 or the transportation server 104 over the communication network 110. The driver device 106a periodically transmits the real-time booking status and position information of the vehicle 112a to the database server 102 or the transportation server 104. The real-time booking status information may indicate whether the vehicle 112a is currently occupied or is available for the new booking request. The real-time position information may indicate the current location information (e.g., spatial-temporal location information) of the driver device 106a, which in turn is indicative of the current location information (e.g., spatial-temporal location information) of the vehicle 112a. The driver device 106a includes one or more position-tracking sensors for tracking the real-time position information by way of a navigation system, such as a global positioning system (GPS).

In an embodiment, the driver device 106a may further detect vehicle dynamics information, such as speed, acceleration, deceleration, or the like, of the vehicle 112a and transmits the vehicle dynamics information to the transportation server 104. In an exemplary embodiment, the driver device 106a may be a vehicle head unit. In another exemplary embodiment, the driver device 106a may be a communication device, such as a smartphone, a tablet, a laptop, or any other portable communication device, that is placed in the vehicle 112a. Various functionalities of other driver devices, such as the driver devices 106b and 106c, are similar to various functionalities of the driver device 106a, as described above.

The passenger device 108a may include suitable logic, circuitry, interfaces, and/or code, executable by the circuitry, that may be configured to perform one or more operations. In an embodiment, the passenger device 108a is a computing device that is used by the passenger 114a to perform one or more activities by means of a service application installed on the passenger device 108a. For example, the passenger 114a uses the passenger device 108a to initiate a booking request for a ride. For initiating the booking request, the passenger 114a inputs ride information, such as her pick-up location, her drop-off location, her pick-up time, or the like, for the ride by means of the service application. The passenger device 108a further transmits the booking request to the transportation server 104 by means of the service application over the communication network 110. The passenger 114a may further use the passenger device 108a to input her preferences for various parameters.

In response to the booking request, the passenger device 108a receives one or more sets of instructions from the transportation server 104 to render a third user interface by means of the service application. Thereafter, the passenger device 108a displays the third user interface including at least a ride fair, a vehicle type, an estimated pick-up time, or the like for the ride. The third user interface may further include one or more options that enable the passenger 114a to confirm or reject the ride. The passenger device 108a further receives the allocation information (corresponding to the booking request) from the transportation server 104 by means of the service application. Examples of the passenger device 108a include, but are not limited to, a smartphone, a tablet, a laptop, or any other portable communication device. Various functionalities of other passenger devices, such as the passenger devices 108b and 108c, are similar to various functionalities of the passenger device 108a, as described above.

The communication network 110 may include suitable logic, circuitry, interfaces, and/or code, executable by the circuitry, that may be configured to transmit queries, data, content, messages, and requests between various entities, such as the database server 102, the transportation server 104, the driver devices 106a-106c, and the passenger devices 108a-108c. Examples of the communication network 110 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, or any combinations thereof. Various entities in the environment 100 may connect to the communication network 110 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

FIG. 2 is a block diagram 200 that illustrates the transportation server 104, in accordance with an embodiment of the present disclosure. The transportation server 104 includes circuitry such as a processor 202, a memory 204, a distance calculator 206, a travel-time predictor 208, a fare calculator 210, a routing engine 212, and a transceiver 214.

The processor 202 may include suitable logic, circuitry, interfaces, and/or codes, executable by the circuitry, that may be configured to perform one or more operations. In an embodiment, the processor 202 receives the booking requests from the passenger devices 108a-108c of the passengers 114a-114c, respectively, by way of the transceiver 214 over the communication network 110. The processor 202 stores the booking requests in the memory 204. The processor 202 further retrieves the real-time booking status and position information of the set of vehicles (associated with the transport service provider) from the database server 102 and processes the real-time booking status information to identify the one or more vehicles, such as the vehicles 112a-112c, that are currently available for new allocation. The real-time position information is further processed to determine the current location of each vehicle. The processor 202 may further identify the one or more vehicles, such as the vehicles 112a-112c, based on at least their current locations. For example, if a current location of a vehicle (e.g., the vehicle 112a) is within a defined threshold distance of a pick-up location of a passenger (e.g., the passenger 114a), and the vehicle (e.g., the vehicle 112a) is available for new allocation, then the processor 202 identifies the vehicle (e.g., the vehicle 112a) as an available vehicle. Upon identification of the vehicles 112a-112c, the processor 202 retrieves the driver and vehicle information associated with each of the drivers and the vehicles 112a-112c from the database server 102 and stores it in the memory 204.

Further, the processor 202 identifies the booking request-vehicle pairs by associating each booking request (received from each of the passenger devices 108a-108c) with each of the vehicles 112a-112c. with respect to ongoing example, the processor 202 identifies first through ninth booking request-vehicle pairs by associating each of the three booking requests with each of the three vehicles (i.e., the vehicles 112a-112c). For example, the processor 202 determines the first booking request-vehicle pair by associating a first booking request (received from the passenger device 108a) with the vehicle 112a, the second booking request-vehicle pair by associating the first booking request with the vehicle 112b, the third booking request-vehicle pair by associating the first booking request with the vehicle 112c, and so on.

Further, the processor 202 selects the plurality of parameters from the set of parameters based on the preferences defined by the drivers of the vehicles 112a-112c, the passengers 114a-114c, the administrator of the transport service provider, or a combination thereof. The set of parameters includes one or more parameters, such as, but not limited to, the pick-up distance, the pick-up time, the ride cost, the dry run, the idle time, the driver rating, the passenger rating, the GMV, the ENV, and the vehicle type. For simplicity of the ongoing discussion, only three parameters, such as “pick-up distance”, “pick-up time”, and “ride cost”, are selected from the plurality of parameters and being considered for describing the present disclosure with limiting the scope of the present disclosure.

In an embodiment, for each parameter of the plurality of parameters, the processor 202 generates a matrix. For example, for the parameter “pick-up distance”, the processor 202 generates a first matrix based on parameter values of the parameter “pick-up distance” associated with each booking request-vehicle pair. The first matrix includes rows and columns that are determined based on the number of booking requests (e.g., 3 booking requests) and the number of available vehicles (e.g., 3 vehicles 112a-112c), respectively, or vice-versa. Thus, the number of elements in the first matrix is equal to the number of booking request-vehicle pairs (i.e., “3*3=9 elements” in the ongoing exemplary scenario). Each element represents a parameter value of the parameter “pick-up distance” for which the first matrix is generated. Further, each element is associated with a different booking request-vehicle pair. For example, a first element is associated with the first booking request-vehicle pair, a second element is associated with the second booking request-vehicle pair, a third element is associated with the third booking request-vehicle pair, and so on. Similarly, for the parameters “pick-up time” and “ride cost”, the processor 202 generates a second matrix and a third matrix. Thus, the processor 202 generates the plurality of matrices, such as the first, second, and third matrices corresponding to the plurality of parameters, such as “pick-up distance”, “pick-up time”, and “ride cost”, respectively.

In an embodiment, the processor 202 processes the plurality of matrices using their respective weights and generates a fourth matrix (i.e., the unified matrix). In an embodiment, each weight is a numerical value between “0” and “1”. In one example, the processor 202 may retrieve the weight of each parameter from the database server 102. In another example, the processor 202 may retrieve the weight of each parameter from the administrator computing device (not shown) of the administrator associated with the transport service provider. The fourth matrix includes rows and columns. In one scenario, each row of the fourth matrix is associated with a booking request (such as the first, second, or third booking request) and each column of the fourth matrix is associated with a vehicle (such as the vehicle 112a, 112b, or 112c), or vice-versa. Thus, each element of the fourth matrix also corresponds to one distinct booking request-vehicle pair.

In an exemplary embodiment, each element of the fourth matrix is obtained by using equation (1):

E_{xy}=[P1_{xy}*W1]*[P2_{xy}*W2]*[P3_{xy}*W3]*[P4_{xy}*W4]* . . . *[PN_{xy}*WN] (1)

where,
x is a booking request such as the first, second, or third booking request,
y is a vehicle such as the vehicle 112a, 112b, or 112c,
E_{xy} is an element of the fourth matrix, where x is a row number corresponding to the booking request and y is a column number corresponding to the vehicle,
P1 through PN are first through N^{th} parameters, and
P1_{xy} through PN_{xy} are parameter values for each booking request-vehicle pair.

The processor 202 further processes the fourth matrix using the one or more algorithms, such as the Hungarian algorithm, to obtain a fifth matrix (i.e., the optimized matrix) including the plurality of optimized values. Thereafter, the processor 202 allocates the vehicles 112a-112c to the passengers 114a-114c based on the optimized values of the fifth matrix. The generation of first, second, third, fourth, and fifth matrices have been described in detail in conjunction with FIGS. 3A-3C. Examples of the processor 202 include, but are not limited to, an application-specific integrated circuit (ASIC) processor, a reduced instruction set computing (RISC) processor, a complex instruction set computing (CISC) processor, or a field-programmable gate array (FPGA). It will be apparent to a person skilled in the art that the processor 202 is compatible with multiple operating systems.

The memory 204 includes suitable logic, circuitry, and/or interfaces to store one or more sets of instructions, programs, codes, and/or scripts that are executed by the processor 202, the distance calculator 206, the travel-time predictor 208, the fare calculator 210, the routing engine 212, and the transceiver 214 to perform their respective operations. The memory 204 further stores the booking information, the parameter values, the allocation information, the passenger information, the driver information, the vehicle information, or the like. The memory 204 further includes a data structure that temporarily stores the plurality of matrices, such as the first, second, third, fourth, and fifth matrices. Examples of the memory 204 include, but are not limited to, a random-access memory (RAM), a read-only memory (ROM), a programmable ROM (PROM), an erasable PROM (EPROM), a hard disk drive (HDD), a secure digital (SD) card, and the like.

The distance calculator 206 may include suitable logic, circuitry, interfaces, and/or codes, executable by the circuitry, that may be configured to perform one or more operations. For example, for each booking request-vehicle pair, the distance calculator 206 determines the pick-up distance based on the pick-up location associated with a passenger (such as the passenger 114a, 114b, or 114c) and the current location associated with a vehicle (such as the vehicle 112a, 112b, or 112c) and stores it in the memory 204. The distance calculator 206 also determines a ride distance associated with each ride based on the pick-up and drop-off locations associated with each booking request and stores it in the memory 204. The distance calculator 206 may further communicate the pick-up distance for each booking request-vehicle pair and the ride distance associated with each ride to the processor 202 by way of an internal communication bus (not shown) of the transportation server 104. The distance calculator 206 may be realized by use of one or more mathematical models, statistical models, algorithms, or a combination thereof. Further, the distance calculator 206 may be implemented using an ASIC processor, a RISC processor, a CISC processor, a FPGA, or a combination thereof.

The travel-time predictor 208 may include suitable logic, circuitry, interfaces, and/or codes, executable by the circuitry, that may be configured to perform one or more operations. For example, the travel-time predictor 208 determines the pick-up time associated with each booking request-vehicle pair based on at least the pick-up location of the passenger (such as the passenger 114a, 114b, or 114c), the current location of the vehicle (such as the vehicle 112a, 112b, or 112c), the real-time traffic conditions between the pick-up and current locations, a speed of the vehicle (or an average defined speed), or a combination thereof, and stores it in the memory 204. The speed of the vehicle may be determined based on an average of historical speeds associated with the vehicle. The travel-time predictor 208 further determines an estimated ride time for each ride based on at least the pick-up and drop-off locations, the real-time traffic conditions between the pick-up and drop-off locations, the speed of the vehicle, or a combination thereof, and stores it in the memory 204. The travel-time predictor 208 may also communicate the pick-up time and the estimated ride time to the processor 202 by way of the internal communication bus. The travel-time predictor 208 may be realized by use of one or more mathematical models, statistical models, algorithms, or a combination thereof. Further, the travel-time predictor 208 may be implemented using an ASIC processor, a RISC processor, a CISC processor, a FPGA, or a combination thereof.

The fare calculator 210 may include suitable logic, circuitry, interfaces, and/or codes, executable by the circuitry, that may be configured to perform one or more operations. For example, the fare calculator 210 determines the ride fare for each ride based on at least one of the ride distance, the ride time, the vehicle type, or the number of passengers associated with each ride. The fare calculator 210 may be realized by use of one or more mathematical models, statistical models, algorithms, or a combination thereof. Further, the fare calculator 210 may be implemented using an ASIC processor, a RISC processor, a CISC processor, a FPGA, or a combination thereof.

The routing engine 212 may include suitable logic, circuitry, interfaces, and/or codes, executable by the circuitry, that may be configured to perform one or more operations. For example, the routing engine 212 determines routing information for each ride based on the pick-up and drop-off locations associated with each ride. The routing information includes at least one route including the pick-up and drop-off locations along which the driver may drive the vehicle (such as the vehicle 112a, 112b, or 112c) to transport the passenger (such as the passenger 114a, 114b, or 114c) from the pick-up location to the drop-off location. Based on the routing information, the processor 202 may generate the electronic map for each ride that may be used by each driver to navigate across various locations. The routing engine 212 may be realized by use of one or more mathematical models, statistical models, algorithms, or a combination thereof. Further, the routing engine 212 may be implemented using an ASIC processor, a RISC processor, a CISC processor, a FPGA, or a combination thereof.

The distance calculator 206, the travel-time predictor 208, the fare calculator 210, and the routing engine 212 have been shown and described as separate entities in conjunction with FIG. 2. However, a person having ordinary skill in the art will appreciate that the distance calculator 206, the travel-time predictor 208, the fare calculator 210, and the routing engine 212 may be implemented by means of a single processor, such as the processor 202, without departing from the scope of the present disclosure. Thus, in such a scenario, the processor 202 may be configured to perform the various operations of the distance calculator 206, the travel-time predictor 208, the fare calculator 210, and the routing engine 212 without departing from the spirit of the present disclosure.

The transceiver 214 includes suitable logic, circuitry, and/or interfaces to transmit and/or receive messages to and/or from various devices, such as the database server 102, the driver devices 106a-106c, and the passenger devices 108a-108c. The transceiver 214 communicates with the database server 102, the driver devices 106a-106c, and the passenger devices 108a-108c over the communication network 110. Examples of the transceiver 214 include, but are not limited to, an antenna, a radio frequency transceiver, a wireless transceiver, and the like. The transceiver 214 communicates with the database server 102, the driver devices 106a-106c, and the passenger devices 108a-108c using various wired and wireless communication protocols, such as TCP/IP, UDP, 2G, 3G, 4G, 5G communication protocols, or any combination thereof.

Referring now to FIG. 3A, exemplary tabular diagrams 300A are shown, in accordance with an embodiment of the present disclosure. The exemplary tabular diagrams 300A include the first matrix 302, the second matrix 304, and the third matrix 306. The first matrix 302 corresponds to the parameter “pick-up distance”, the second matrix 304 corresponds to the parameter “pick-up time”, and the third matrix corresponds to the parameter “ride cost”. Further, the first, second, and third booking requests are represented by “R1”, “R2”, and “R3”, respectively, and the vehicles 112a, 112b, and 112c are represented by “V1”, “V2”, and “V3”, respectively, as shown in FIG. 3A.

In an embodiment, the processor 202 generates the first, second, and third matrices 302, 304, and 306 based on the parameter values of the parameters “pick-up distance”, “pick-up time”, and “ride cost”, respectively, associated with each of the nine booking request-vehicle pairs. The nine booking request-vehicle pairs are R1-V1, R1-V2, R1-V3, R2-V1, R2-V2, R2-V3, R3-V1, R3-V2, and R3-V3. Further, each of the first, second, and third matrices 302, 304, and 306 includes 3 rows and 3 columns, and thus includes 9 elements (=3*3). Each element is represented by the corresponding parameter value. For example, in the first matrix 302, an element e11 corresponding to the booking request-vehicle pair R1-V1 is represented by a parameter value “3 KM” that indicates the pick-up distance between the vehicle 112a and the passenger 114a. An element e12 corresponding to the booking request-vehicle pair R1-V2 is represented by a parameter value “1 KM” that indicates the pick-up distance between the vehicle 112b and the passenger 114a. An element e13 corresponding to the booking request-vehicle pair R1-V3 is represented by a parameter value “9 KM” that indicates the pick-up distance between the vehicle 112c and the passenger 114a. Similarly, in the first matrix 302, elements e21, e22, e23, e31, e32, and e33 corresponding to the booking request-vehicle pairs R2-V1, R2-V2, R2-V3, R3-V1, R3-V2, and R3-V3 are represented by the parameter values “7 KM”, “0.5 KM”, “3 KM”, “5.5 KM”, “4 KM”, and “6 KM”, respectively.

Further, in the second matrix 304, an element e11 corresponding to the booking request-vehicle pair R1-V1 is represented by a parameter value “5 minutes” that indicates the pick-up time at which the driver of the vehicle 112a will pick-up the passenger 114a from her pick-up location. An element e12 corresponding to the booking request-vehicle pair R1-V2 is represented by a parameter value “6 minutes” that indicates the pick-up time at which the driver of the vehicle 112b will pick-up the passenger 114a from her pick-up location. An element e13 corresponding to the booking request-vehicle pair R1-V3 is represented by a parameter value “13 minutes” that indicates the pick-up time at which the driver of the vehicle 112c will pick-up the passenger 114a from her pick-up location. Similarly, in the second matrix 304, elements e21, e22, e23, e31, e32, and e33 corresponding to the booking request-vehicle pairs R2-V1, R2-V2, R2-V3, R3-V1, R3-V2, and R3-V3 are represented by the parameter values “15 minutes”, “8 minutes”, “3 minutes”, “10 minutes”, “11 minutes”, and “9 minutes”, respectively.

Further, in the third matrix 306, an element e11 corresponding to the booking request-vehicle pair R1-V1 is represented by a parameter value “INR 300” that indicates the ride cost for the ride when the vehicle 112a will be allocated to the passenger 114a for the ride. An element e12 corresponding to the booking request-vehicle pair R1-V2 is represented by a parameter value “INR 200” that indicates the ride cost for the ride when the vehicle 112b will be allocated to the passenger 114a for the ride. An element e13 corresponding to the booking request-vehicle pair R1-V3 is represented by a parameter value “INR 1200” that indicates the ride cost for the ride when the vehicle 112c will be allocated to the passenger 114a for the ride. Similarly, in the third matrix 306, elements e21, e22, e23, e31, e32, and e33 corresponding to the booking request-vehicle pairs R2-V1, R2-V2, R2-V3, R3-V1, R3-V2, and R3-V3 are represented by the parameter values “INR 100”, “INR 1050”, “INR 400”, “INR 335”, “INR 500”, and “INR 800”, respectively.

Referring now to FIG. 3B, an exemplary tabular diagram 300B is shown, in accordance with an embodiment of the present disclosure. The exemplary tabular diagram 300B represents the fourth matrix 308 (i.e., the unified matrix). The processor 202 processes the first, second, and third matrices 302, 304, and 306 and generates the fourth matrix 308. Prior to processing of the first, second, and third matrices 302, 304, and 306, the processor 202 retrieves the weight for each of the parameters “pick-up distance”, “pick-up time”, and “ride cost” from the database server 102 or the memory 204. In another embodiment, the weight for each parameter may be received in real-time from the administrator computing device of the administrator associated with the transport service provider. In an embodiment, a numerical value of the weight is greater than or equal to “0” and less than or equal to “1”. For simplicity of the ongoing discussion, the weights of the parameters “pick-up distance”, “pick-up time”, and “ride cost” are identified as “0.5”, “0.2”, and “0.6”, respectively. Thereafter, the processor 202 processes the first, second, and third matrices 302, 304, and 306 using their respective weights to generate the fourth matrix 308. In an embodiment, elements of the fourth matrix 308 may be determined using the equation (1) as described above. For example, an element Eu of the fourth matrix is determined as:

E₁₁=[3*0.5]*[5*0.2]*[300*0.6]=270

Similarly, other elements E₁₂, E₁₃, E₂₁, E₂₂, E₂₃, E₃₁, E₃₂, and E₃₃ of the fourth matrix 308 are determined as “72”, “8424”, “630”, “252”, “216”, “1105”, “1320”, and “2592”, respectively, as shown.

Referring now to FIG. 3C, an exemplary tabular diagram 300C is shown, in accordance with an embodiment of the present disclosure. The exemplary tabular diagram 300C represents the fifth matrix 310 (i.e., the optimized matrix). The processor 202 processes the fourth matrix 308 using the one or more algorithms, such as the Hungarian algorithm, to generate the fifth matrix 310 including a plurality of elements. For example, the processor 202 performs row operations on the fourth matrix 308. To execute the row operations, the processor 202 identifies a minimum value in each row of the fourth matrix 308. For example, “72”, “216”, and “1105” are minimum values associated with a first row (including E₁₁, E₁₂, and E₁₃), a second row (E₂₁, E₂₂, and E₂₃), and a third row (E₃₁, E₃₂, and E₃₃) of the fourth matrix 308, respectively. Thereafter, the processor 202 performs a subtraction operation in which the minimum value of the row is subtracted from each element in that row. After the subtraction operation, the value of at least one element will be zero in that row, as shown in FIG. 3C. Thus, the processor 202 generates the fifth matrix 310 with at least one zero per row. Thereafter, the processor 202 performs a check to determine presence of at least two zero in the same column of the fifth matrix 310. In a scenario where there is no column in the fifth matrix 310 including at least two zeros, then the fifth matrix 310 is determined as the optimized matrix. However, in a scenario where at least one column of the fifth matrix 310 includes at least two zeros, then the processor 202 performs the above procedure for all columns of the fifth matrix 310 (i.e., the minimum value in each column is subtracted from all the elements in that column), and then the processor 202 performs a check to determine if allocation is possible. In the ongoing exemplary scenario, the fifth matrix 310 is determined as the optimized matrix since each row includes at least one zero per row and no column includes at least two zeros. Thereafter, the processor 202 allocates the vehicles 112a-112c to the passengers 114a-114c. For example, the vehicle 112a is allocated to the passenger 114c (who has initiated the third booking request “R3”), the vehicles 112b is allocated to the passenger 114a (who has initiated the first booking request “R1”), and the vehicle 112c is allocated to the passenger 114b (who has initiated the second booking request “R2”).

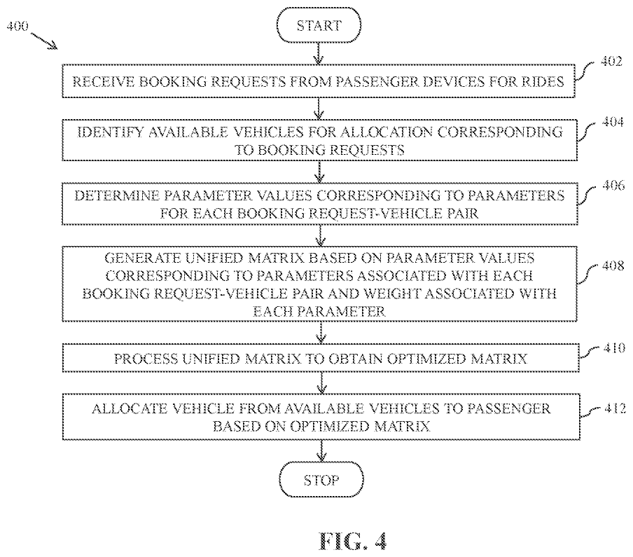

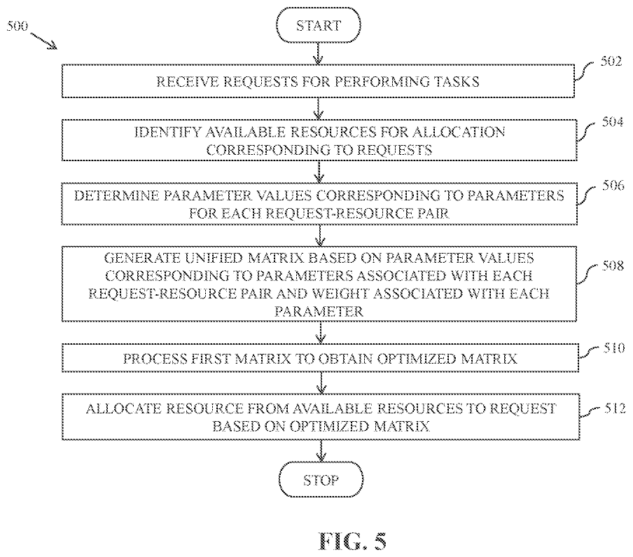

Referring now to FIG. 4, a flow chart 400 that illustrates a method for optimizing vehicle allocation in a transportation system is shown, in accordance with an embodiment of the present disclosure.

At step 402, the transportation server 104 receives the booking requests from the passenger devices 108a-108c for the rides over the communication network 110. Each booking request includes at least the pick-up location, the drop-off location, the vehicle type, the number of passengers, or a combination thereof.

At step 404, the transportation server 104 identifies the available vehicles (i.e., the vehicles 112a-112c) for allocation corresponding to the received booking requests. The available vehicles are identified based on at least the real-time booking status and position information of each vehicle. The available vehicles may further be identified in conjunction with the pick-up location associated with each booking request.

At step 406, the transportation server 104 determines the parameter values corresponding to the parameters for each booking request-vehicle pair. The parameters include at least the pick-up distance, the pick-up time, the ride cost, the dry run, the idle time, the driver rating, the passenger rating, the GMV, the ENV, and the vehicle type associated with each booking request-vehicle pair.

At step 408, the transportation server 104 generates the fourth matrix 308 (i.e., the unified matrix) based on the parameter values corresponding to the parameters for each booking request-vehicle pair and the weight associated with each parameter. For example, firstly, the transportation server 104 generates the matrices, such as the first, second, and third matrices 302, 304, and 306, based on the parameter values of the parameters, such as the parameters “pick-up distance”, “pick-up time”, and “ride cost”, respectively. Thereafter, the transportation server 104 processes the matrices using the weight of each parameter and generates the fourth matrix 308 (i.e., the unified matrix), as described above in conjunction with FIGS. 3A and 3B.

At step 410, the transportation server 104 processes the fourth matrix 308 (i.e., the unified matrix) to generate the fifth matrix 310 (i.e., the optimized matrix). The fourth matrix 308 is processed using the Hungarian algorithm, as described above in conjunction with FIG. 3C.

At step 412, the transportation server 104 allocates the available vehicles (such as the vehicles 112a-112c) to the passengers 114a-114c. In an embodiment, the vehicles 112a-112c are allocated to the passengers 114a-114c based on the fifth matrix 310 (i.e., the optimized matrix), as described above in conjunction with FIG. 3C.

Referring now to FIG. 5, a flow chart 500 that illustrates a method for optimizing resource allocation for tasks is shown, in accordance with an embodiment of the present disclosure. In one example, the method is implemented by a processor of a remote server (e.g., the processor 202 of the transportation server 104) in a worker-job environment for allocating one or more resources, such as employees, to perform one or more tasks, such as projects, in an organization.

At step 502, the processor 202 receives requests for performing tasks. For example, the processor 202 receives the requests for completing one or more projects by employees of an organization.

At step 504, the processor 202 identifies resources that are available for allocation corresponding to the received requests. For example, the processor 202 identifies employees that have not been allocated to any project or are allocated to few projects and have sufficient bandwidth to take up new projects.

At step 506, the processor 202 determines parameter values corresponding to parameters for each request-resource pair. In one example, the parameters include a time taken by an employee to complete a project, an experience of the employee, an accuracy of the employee, a cost of completing the project by the employee, or the like. The processor 202 may determine the parameter values corresponding to the parameters for each request-employee pair based on historical performance data stored by the organization. Each parameter is associated with a weight specified by the organization.

At step 508, the processor 202 generates a unified matrix based on the parameter values and the weight associated with each parameter. The unified matrix is generated in a manner that is similar to the generation of the fourth matrix 308, as described above in conjunction with FIG. 3B.

At step 510, the processor 202 processes the unified matrix (generated in step 508) to obtain an optimized matrix. In one embodiment, the processor 202 processes the unified matrix by way of the Hungarian algorithm to obtain the optimized matrix. Here, the optimized matrix is generated in a manner that is similar to the generation of the fifth matrix 310, as described above in conjunction with FIG. 3C.

At step 512, the processor 202 allocates a resource from the available resources to each request based on the optimized matrix (generated in step 508).

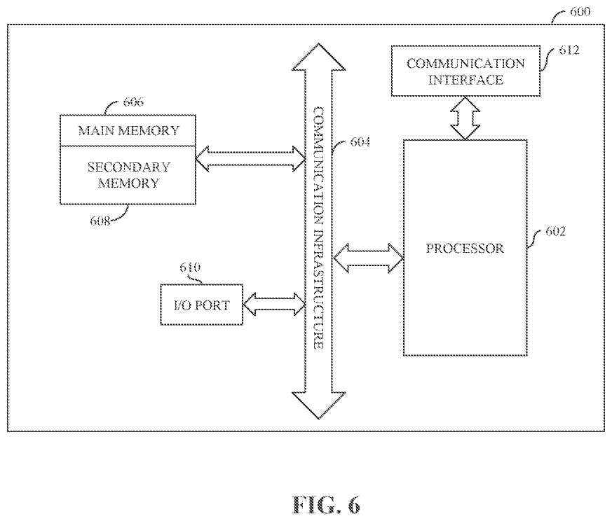

Referring now to FIG. 6, a block diagram of a computer system 600 for optimizing vehicle allocation to passengers is shown, in accordance with an embodiment of the present disclosure. An embodiment of present disclosure, or portions thereof, may be implemented as computer readable code on the computer system 600. In one example, the database server 102 and the transportation server 104 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

The computer system 600 includes a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 110, multi-core message-passing scheme, and the like. The computer system 600 further includes a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 further includes an I/O port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may correspond to signals, such as electronic, electromagnetic, optical, or other signals as will be apparent to a person skilled in the art. The signals may travel via a communications channel, which may be configured to transmit the signals to devices that are communicatively coupled to the computer system 600. Examples of the communication channel may include, but are not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the method illustrated in FIGS. 4 and 5. In an embodiment, the present disclosure is implemented using a computer implemented application, such as the service application of the passenger devices 108a-108c The computer implemented application may be stored in a computer program product and loaded into the computer system 600 using the removable storage drive or the hard disc drive in the secondary memory 608, the I/O port 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 602 and a memory such as the main memory 606 and the secondary memory 608 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

The method and the system for optimizing vehicle allocation facilitate efficient and effective allocation of vehicles (e.g., the vehicles 112a-112c) associated with the transportation service provider to passengers (e.g., the passengers 114a-114c). The allocation of the vehicles is based on multiple parameters provided by the transportation service provider. The multiple parameters are related to rides, vehicles, drivers of the vehicles, and the passengers. The multiple parameters are evaluated simultaneously using their respective weight values to perform allocation of the vehicles to the passengers. Also, additional parameters may be added in real-time by the transportation service provider based on business requirements. The weights associated with the parameters can be specified by the transportation service provider. Thus, the numerical values of the weights associated with certain parameters can be increased if those parameters are important, or vice-versa. Additionally, the disclosed method and system offers flexibility to the transportation service provider as the weights can be adjusted at any time instant based on the business requirements, real-time demand, and real-time supply. Further, the method of FIG. 4 can be implemented for any number of booking requests and any number of available vehicles. The method of FIG. 4 offers the most efficient and effective ways of allocation of the vehicles for scenarios where a single booking request is received and more than one vehicles are available for allocation, along with scenarios where more than one booking requests have been received and only one vehicle is available for allocation.

Techniques consistent with the present disclosure provide, among other features, a method and system for resource allocation using weighted metrics. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method, comprising:
receiving, by circuitry, one or more booking requests for one or more rides from one or more passenger devices, respectively, via a communication network;
identifying, by the circuitry, one or more vehicles that are available for allocation corresponding to the one or more booking requests, based on an availability status of each vehicle;
generating, by the circuitry, a first matrix including a plurality of elements, wherein each element corresponds to a booking request-vehicle pair, and wherein each element is determined based on a plurality of parameter values corresponding to a plurality of parameters associated with the booking request-vehicle pair and a weight associated with each parameter;
processing, by the circuitry, the first matrix by executing one or more algorithms including at least a Hungarian algorithm to generate a second matrix; and
allocating, by the circuitry, based on the second matrix, a vehicle from the one or more available vehicles to a passenger for a ride.

2. The method of claim 1, wherein each booking request includes at least a pick-up location and a drop-off location, and wherein each vehicle is associated with a driver having at least a driver rating.

3. The method of claim 1, wherein the plurality of parameters comprise at least a pick-up distance, a pick-up time, a ride cost, a dry run, an idle time, a driver rating, a passenger rating, a gross merchandise value (GMV), an earning normalizing value (ENV), and a vehicle type associated with the booking request-vehicle pair.

4. The method of claim 3, wherein the pick-up distance is determined based on a current location of an available vehicle and a pick-up location of a passenger associated with the booking request-vehicle pair.

5. The method of claim 3, wherein the pick-up time is determined based on at least the pick-up distance and traffic conditions along a route associated with the pick-up distance.

6. The method of claim 3, wherein the ride cost for a ride is determined based on at least a type of the ride, a ride distance between pick-up and drop-off locations, and a ride time between the pick-up and drop-off locations.

7. The method of claim 3, wherein the dry run for an available vehicle is determined based on a dry run distance, and wherein the dry run distance is a minimum distance for which the available vehicle is designated to travel without having any passenger in the available vehicle, after allocation of the available vehicle to a passenger for a ride and before picking the passenger from a pick-up location associated with the booking request-vehicle pair.

8. The method of claim 3, wherein the idle time for an available vehicle is determined based on historical allocation information of the available vehicle associated with the booking request-vehicle pair.

9. The method of claim 3, wherein the GMV is determined based on the ride cost and a ride distance between pick-up and drop-off locations associated with the booking request-vehicle pair.

10. The method of claim 3, wherein the ENV is determined based on earnings of one or more drivers associated with the one or more available vehicles.

11. A method, comprising:
receiving, by circuitry, one or more requests for performing one or more tasks;
identifying, by the circuitry, one or more resources that are available for allocation corresponding to the one or more requests;
generating, by the circuitry, a first matrix including a plurality of elements, wherein each element corresponds to each request-resource pair, and wherein each element is determined based on a plurality of parameter values corresponding to a plurality of parameters associated with each booking request-resource pair and a weight associated with each parameter;
processing, by the circuitry, the first matrix by means of one or more algorithms including at least a Hungarian algorithm to generate a second matrix; and
allocating, by the circuitry, based on the second matrix, a resource from the one or more available resources to a request from the one or more requests for performing a task.

12. A system, comprising:
a transportation server comprising circuitry configured to:
receive one or more booking requests for one or more rides from one or more passenger devices of one or more passengers, respectively;
identify one or more vehicles that are available for allocation corresponding to the one or more booking requests;
generate a first matrix including a plurality of elements, wherein each element corresponds to each booking request-vehicle pair, and wherein each element is determined based on a plurality of parameter values corresponding to a plurality of parameters associated with each booking request-vehicle pair and a weight associated with each parameter;
process the first matrix by means of one or more algorithms including at least a Hungarian algorithm to generate a second matrix; and
allocate, based on the second matrix, a vehicle from the one or more available vehicles to a passenger from the one or more passengers for a ride.

13. The system of claim 12, wherein the plurality of parameters comprise at least a pick-up distance, a pick-up time, a ride cost, a dry run, an idle time, a driver rating, a passenger rating, a gross merchandise value (GMV), an earning normalizing value (ENV), or a vehicle type associated with each booking request-vehicle pair.

14. The system of claim 13, wherein the circuitry is further configured to determine the pick-up distance associated with each booking request-vehicle pair based on a current location of an available vehicle and a pick-up location of a passenger associated with each booking request-vehicle pair.

15. The system of claim 13, wherein the circuitry is further configured to determine the pick-up time associated with each booking request-vehicle pair based on at least the pick-up distance and traffic conditions along a route associated with the pick-up distance.

16. The system of claim 13, wherein the circuitry is further configured to determine the ride cost for a ride associated with each booking request-vehicle pair based on at least a type of the ride, a ride distance between pick-up and drop-off locations, and a ride time between the pick-up and drop-off locations.

17. The system of claim 13, wherein the circuitry is further configured to determine the dry run for an available vehicle associated with each booking request-vehicle pair based on a dry run distance, and wherein the dry run distance is a minimum distance for which the available vehicle is designated to travel without having any passenger in the available vehicle, after allocation of the available vehicle to a passenger for a ride, and before picking the passenger from a pick-up location associated with each booking request-vehicle pair.

18. The system of claim 13, wherein the circuitry is further configured to determine the idle time for an available vehicle associated with each booking request-vehicle pair based on historical allocation information of the available vehicle.

19. The system of claim 13, wherein the circuitry is further configured to determine the GMV for each booking request-vehicle pair based on the ride cost and a ride distance between pick-up and drop-off locations associated with each booking request-vehicle pair.

20. The system of claim 13, wherein the circuitry is further configured to determine the ENV for each booking request-vehicle pair based on earnings of one or more drivers associated with the one or more available vehicles.
